(19) United States
(12) Patent Application Publication
(10) Pub. No.: US 2012/0165071 A1
(43) Pub. Date: Jun. 28, 2012

(54) MOBILE DEVICE CAPABLE OF AUTOMATICALLY SWITCHING ITS OPERATION MODES

(75) Inventors: CHIH-JUI HSU, New Taipei City (TW); YI-TING LIU, New Taipei City (TW); SHIENG-TING KAO, New Taipei City (TW); CHING-SUNG CHANG, NEW TAIPEI CITY (TW); JU-NAN CHANG, NEW TAIPEI CITY (TW)

(73) Assignees: INVENTEC APPLIANCES (SHANGHAI) CO. LTD., Shanghai (CN); INVENTEC APPLIANCES CORP., SHANGHAI, Shanghai (CN); INVENTEC APPLIANCES CORP., New Taipei City (TW)

(21) Appl. No.: 13/329,139

(22) Filed: Dec. 16, 2011

(30) Foreign Application Priority Data
Dec. 28, 2010 (CN) 201010609512.X

(51) Int. Cl. H04W 88/02; H04B 1/38

(52) U.S. Cl. 455/557; 455/566

(57) ABSTRACT

A mobile device capable of automatically switching its operation modes includes a storage module, a control module, a display module and an electrical connector. The storage module is configured to store data of icons controllable to execute an application or function. The control module is configured to direct the data of at least one icon from the storage module to be transmitted to the display module for displaying the icon on a screen. When the control module detects that the electrical connector is electrically coupled to an electronic device, the control module is configured to adjust configuration of the at least one icon, with the adjusted configuration to be automatically displayed on the screen to mark a new operation mode of the mobile device. The configuration of the icon may be adjusted in size, one or more pixels, position, or quantity of the icon.

### CROSS-REFERENCE TO RELATED APPLICATION

This application claims the benefit of China Patent Application No. 201010609512.X, filed on Dec. 28, 2010, in the State Intellectual Property Office of the People's Republic of China, the disclosure of which is incorporated herein in its entirety by reference.

### BACKGROUND OF THE INVENTION

1. Field of the Invention

The present invention relates to a mobile device, and particularly to a mobile device capable of automatically switching its operation modes.

2. Brief Description of the Related Art

As mobile broadband Internet and microcomputer technologies advance, various mobile devices with networking and multimedia functions are introduced to the market. Besides the smart phones being popular in recent years, mobile devices such as personal digital assistants (PDAs) and tablet PC become favorable electronic products to users, and these mobile devices come with a volume smaller than personal computers or notebook computers, not only having a light weight for a convenient carry, but also providing plentiful functions such as photographing, playing music, word processing as well as the functions of transmitting and receiving emails via the Internet or downloading and playing streaming media to satisfy different user requirements.

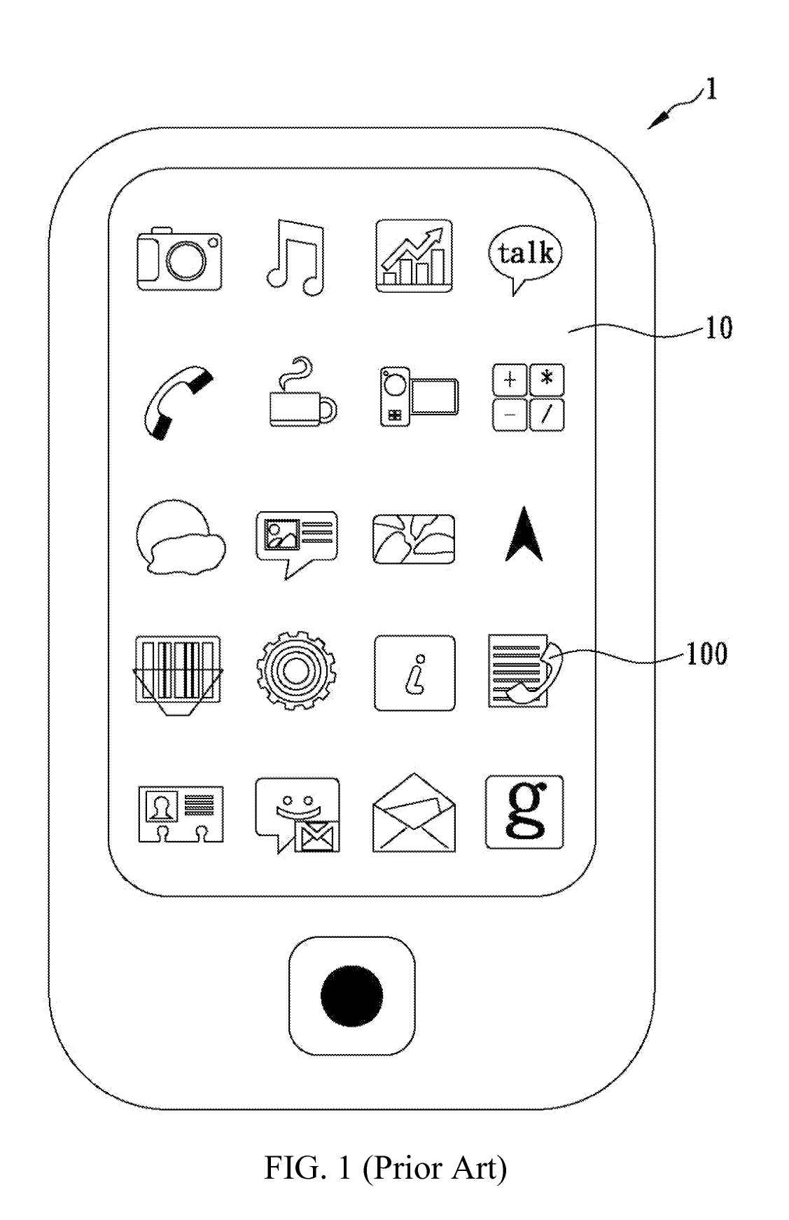

Although the aforementioned mobile devices have powerful functions, the practical use of the mobile devices still has the following drawbacks. For example, a conventional common smart phone (hereinafter referred to a mobile device 1 and as shown in FIG. 1) available in the market comprises a touch screen 10, and the touch screen 10 can display images and texts, and can play the role of an input module by receiving a user's click (or other finger movements). In FIG. 1, the touch screen 10 displays twenty application icons 100, and each icon 100 corresponds to an application (such as a camera or a music player), and users can click a desired icon 100 by a finger touch method to drive the mobile device 1 to execute the corresponding application.

When a user carries and uses a mobile device 1, he usually holds the mobile device 1 by one hand and operates the mobile device 1 by the other hand. As the distance now between the mobile device 1 and the user is generally as short as 30˜60 cm, falling under close operating the mobile device 1, the user will be able to recognize each of the icons 100 clearly and thus operate the mobile device 1, even if the touch screen 10 displays these icons 100 in a smaller size for displaying a plurality of icons 100 at the same time.

However, if the user inserts the mobile device 1 into a battery charger (not shown in the figure) or connects it to another electronic device (such as a speaker) as the user is away from the mobile device 1, the mobile device 1 still displays the icons 100 (as shown in FIG. 1) in a smaller size, and the user will be unable to recognize each of the icons 100 clearly by naked eyes in order to operate the mobile device 1 (such as by a remote-control method) since the distance between the user and the mobile device 1 has been increased, which causes inconvenience to the user. Furthermore, although the user can manually adjust the mobile device 1 in advance to change the operation mode to a remote operation mode and increase the size of the displayed icon 100, once if the user wants to use mobile device 1 for the close or short distance operation, it will take some time and effort for the user to adjust the icon 100 back to the original display size again. Such arrangement not only wastes the user's precious time, but also causes inconvenience for the user to adjust the operation mode repeatedly. Obviously, the prior art requires improvements. It is an important issue of the invention to improve the prior art by providing a mobile device switchable to an appropriate operation mode automatically according to different occasions to enhance the using convenience.

### SUMMARY OF THE INVENTION

In view of the foregoing drawbacks of the prior art, the inventor of the present invention based on years of experience in the related industry conducting extensive researches and experiments, finally developed a mobile device capable of automatically switching its operation modes in accordance with the present invention, so that the mobile device can automatically switch to an appropriate operation mode according to the application requirements, resulting in reducing the manual adjustment time for user and improve the convenience of operating the mobile device.

An objective of the present invention is to provide a mobile device capable of automatically switching its operation modes, wherein the mobile device (such as a mobile phone or a tablet PC) comprises a storage module, a control module, a display module and at least one electrical connector (such as an audio connector or a power connector). The storage module is configured to store data of a plurality of icons, and each of the icons is controllable to execute an application or a function. The display module is configured to display images or data. The electrical connector is configured to couple to an electronic device (such as a speaker or a charger). The control module is coupled to the storage module, the display module and the electrical connector, and is configured to direct the data of at least one of the icons from the storage module to be transmitted to the display module for displaying the at least one icons on a screen of the display module. Accordingly, when the control module detects that the electrical connector is electrically coupled to the electronic device, the control module is configured to adjust configuration of the at least one icon, with the adjusted configuration to be automatically displayed on the screen to mark a new operation mode of the mobile device. In embodiments, the configuration of the at least one icon may be adjusted in size, one or more pixels, position on the screen, or quantity of the at least one icon. Therefore, when a user carries a mobile device and operates the mobile device from a short distance, since the mobile device is normally not connected to any other electronic device, and the configuration of the displayed at least one icon is not adjusted at this time, the display module can display icons having a larger quantity or smaller sizes, more-finely drawn icons, or icons with more colors for the user to use or choose conveniently. On the other hand, if the user electrically connects the mobile device to another electronic device and stays at a position remote from the mobile device, then the mobile device is configured to adjust the configuration of the displayed at least one icon, with the adjusted configuration to be automatically displayed and include icons having a smaller quantity or larger sizes, more-coarsely drawn icons, icons with less or simpler colors, or icons with obvious contrast of their colors, so that the user can still recognize the icons from a relatively long distance and then operate the mobile device by e.g. selecting an icon with a remote-control method to enable the mobile device to execute the application or function corresponding to the selected icon.

In an embodiment of the present invention, when the control module detects that the electrical connector is coupled to the electronic device, the control module is configured to increase size of the at least one icon by a predetermined ratio or different ratios to obtain the adjusted configuration.

In another embodiment of the present invention, when the control module detects that the electrical connector is coupled to the electronic device the control module is configured to reduce quantity of the at least one icon to be displayed on the screen.

In another embodiment of the present invention, when the control module detects that the electrical connector is coupled to the electronic device the control module is configured to convert a primary-color-combination image value of each pixel of the at least one icon into a grayscale image value, a binary-image value, or another primary-color-combination image value, to obtain the adjusted configuration.

In another embodiment of the present invention, the adjusted configuration is to be automatically displayed in a larger area on the screen than an area on the screen in which the configuration before the adjustment is displayed.

In another embodiment of the present invention, the adjusted configuration has icon display order different from the icon display order of the configuration before the adjustment.

In another embodiment of the present invention, when the control module detects that the electrical connector is coupled to the electronic device the control module is configured to determine quantity of the at least one icon to be displayed on the screen, according to times or frequency of execution or usage of the application or function, or according to user-determined priority of the application or function.

With the technical characteristics of the present invention, the mobile device is capable of automatically switching to a short-distance operation mode or a remote operation mode depending on different conditions, without requiring any manual operation by the user to switch between operation modes. Thus the mobile device can automatically switch between operation modes corresponding to and appropriate for using the mobile device from different distances, including close and remote using, thereby not only saving user's time for adjusting the mobile device, but also making operating the mobile device more convenient.

Another objective of the present invention is to provide a mobile device capable of automatically switching its operation modes, wherein the mobile device comprises a storage module, a control module, a display module and an input module. The storage module is configured to store data of a plurality of icons, and each of the icons is controllable to execute an application or a function. The display module is configured to display images or data. The input module (including such as a button) is configured for inputting instructions or data. The control module is coupled to the storage module, the display module, and the input module, and is configured to direct the data of at least one of the icons from the storage module to be transmitted to the display module for displaying the at least one icon on a screen of the display module. In this mobile device, when the control module detects that the input module has not been activated for a predetermined period, the control module is configured to adjust configuration of the at least one icon, with the adjusted configuration to be automatically displayed on the screen to mark a new operation mode of the mobile device. Further, configuration of the at least one icon may be adjusted in size, one or more pixels, position on the screen, or quantity of the at least one icon.

In an embodiment, therefore, when the user lets the mobile device be idle for the predetermined period, the mobile device may automatically switch to a remote operation mode, thereby saving user's time for manually switching an operation mode of the mobile device.

The technical characteristics and effects of the present invention will become apparent with reference to the detailed description of the preferred embodiments together with the illustration of related drawings as follows:

### BRIEF DESCRIPTION OF THE INVENTION

FIG. 1 is a schematic view of a conventional mobile device;

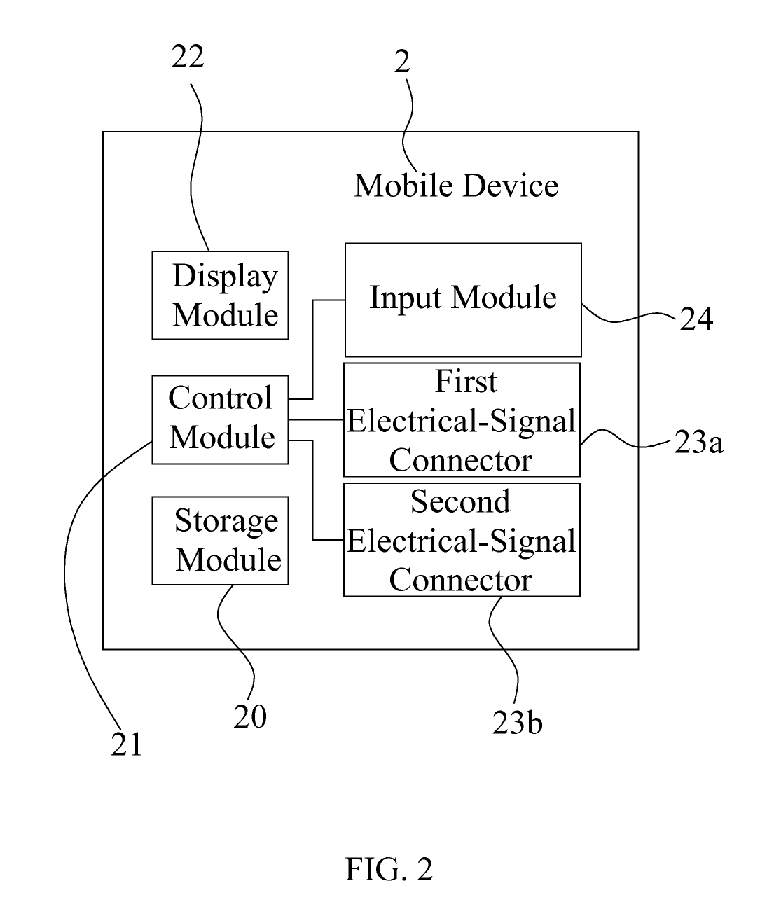

FIG. 2 is a schematic circuit diagram of a mobile device in accordance with embodiments of the present invention;

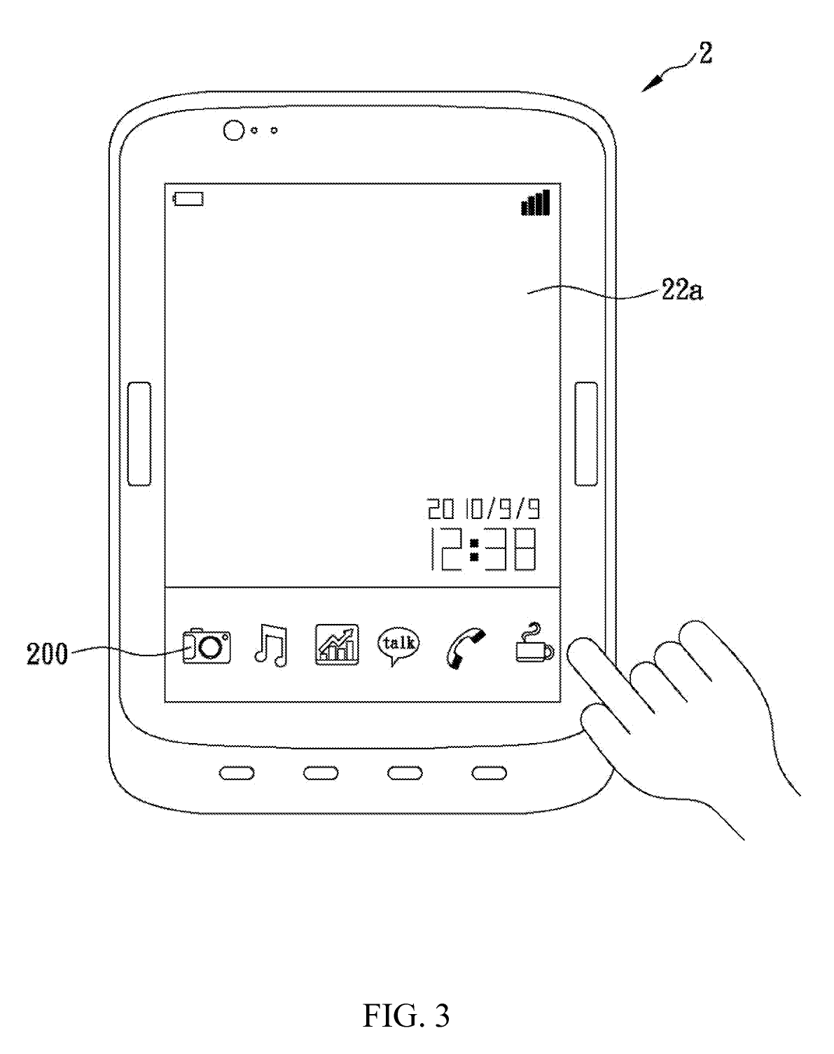

FIG. 3 is a schematic view of a mobile device in a short-distance operation mode in accordance with the first preferred embodiment of the present invention;

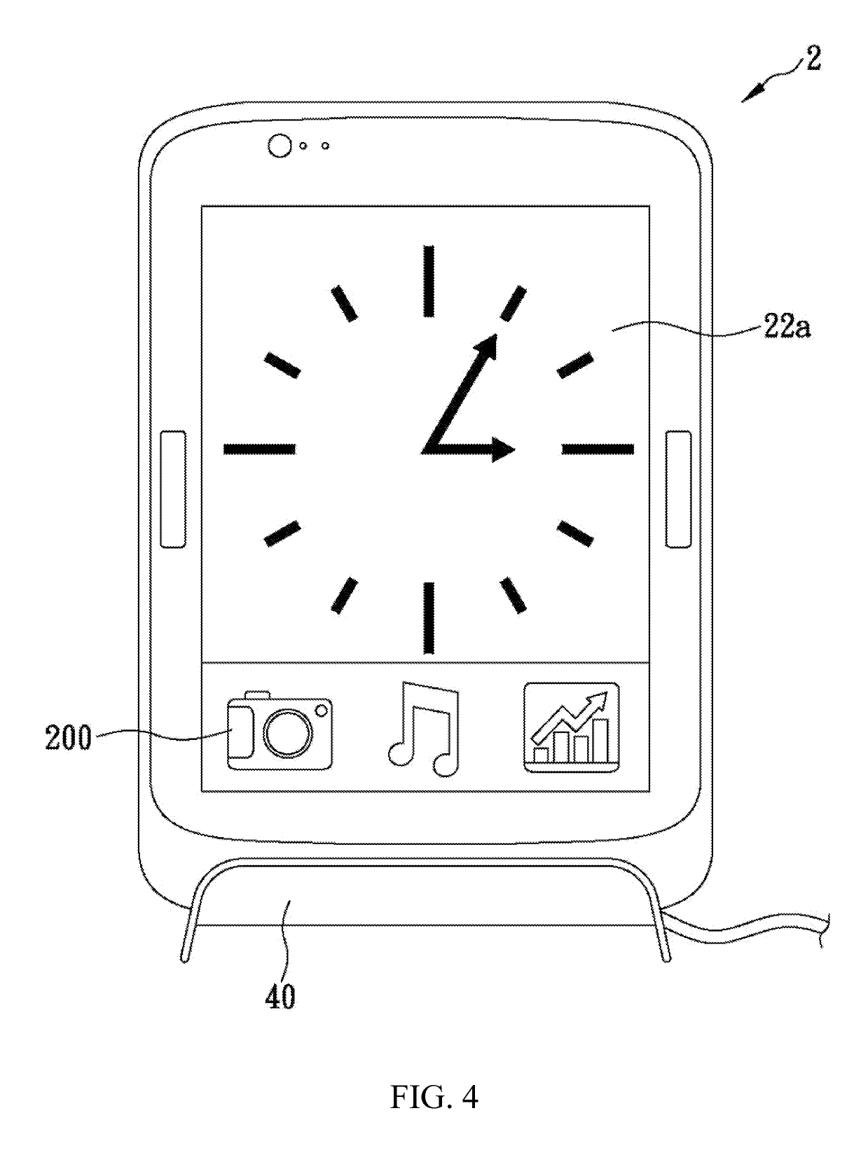

FIG. 4 is a schematic view of a mobile device in a remote operation mode in accordance with the first preferred embodiment of the present invention;

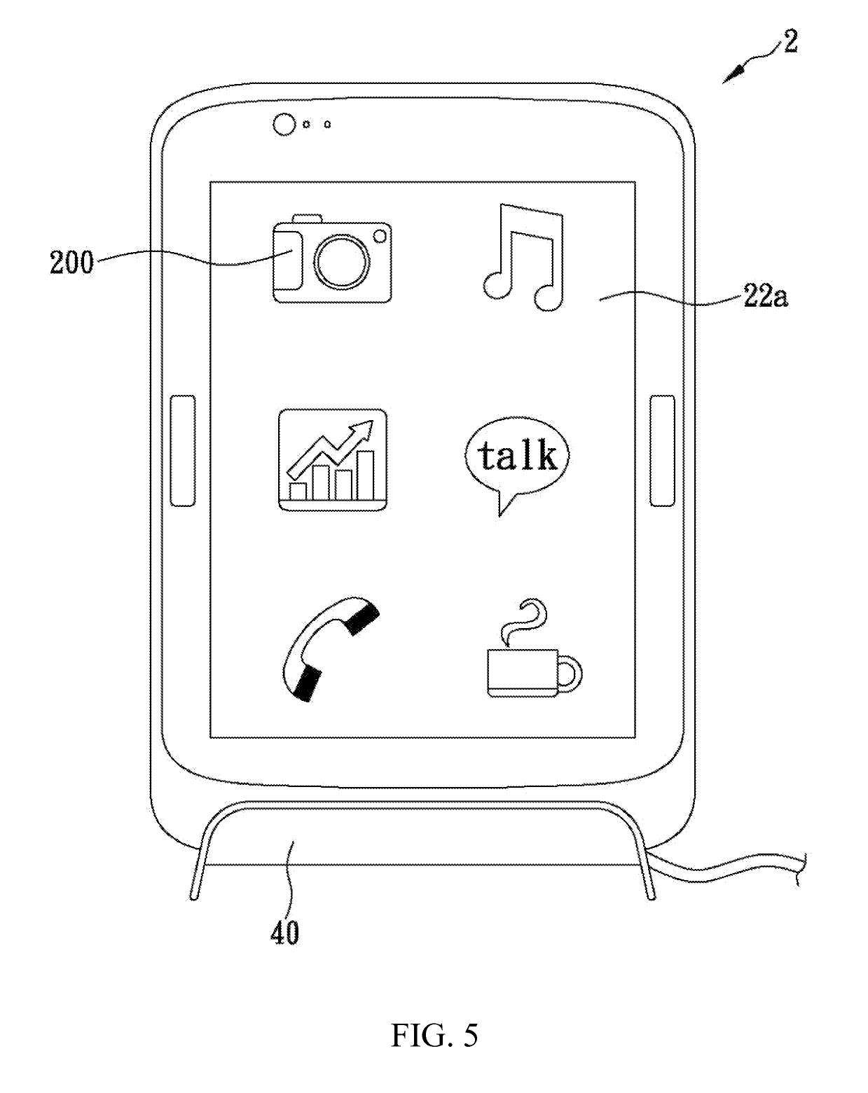

FIG. 5 is another schematic view of a mobile device in a remote operation mode in accordance with the first preferred embodiment of the present invention;

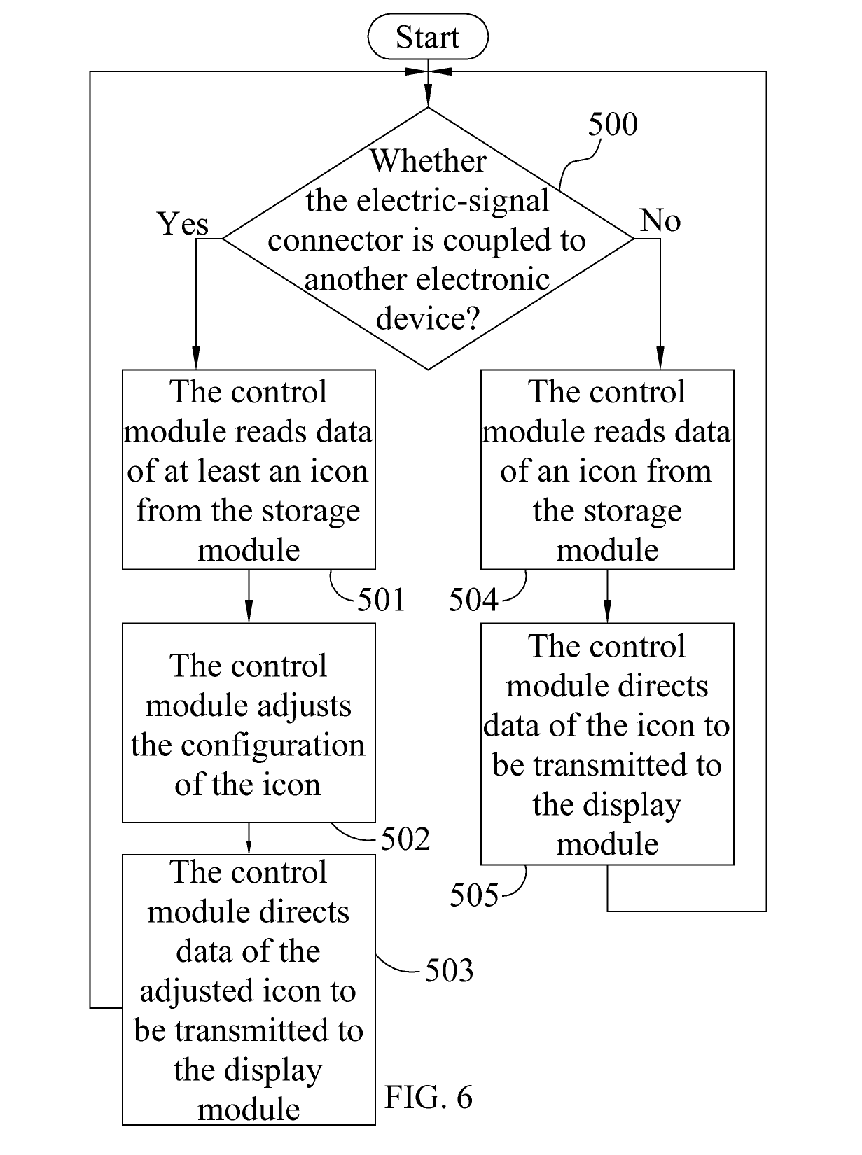

FIG. 6 is a flow chart of a method of automatically switching an operation mode in accordance with the first preferred embodiment of the present invention;

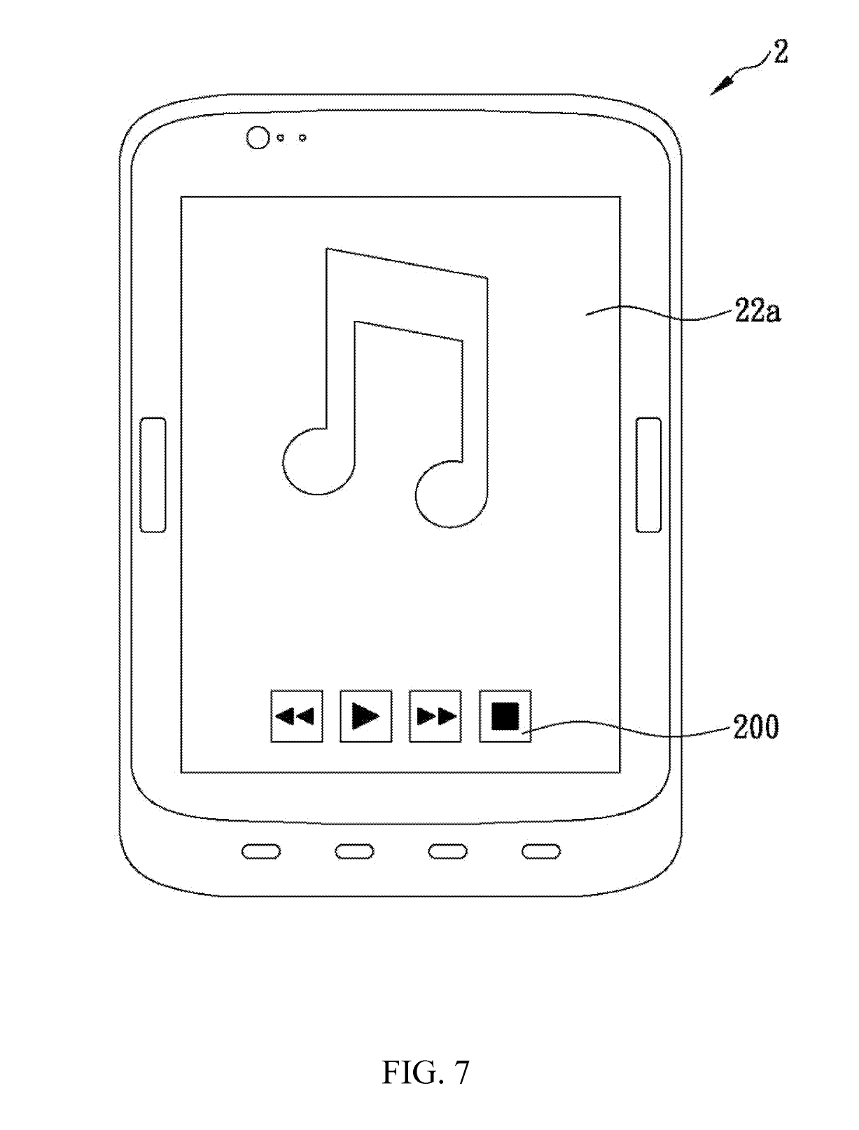

FIG. 7 is a schematic view of a mobile device in a short-distance operation mode in accordance with a second preferred embodiment of the present invention;

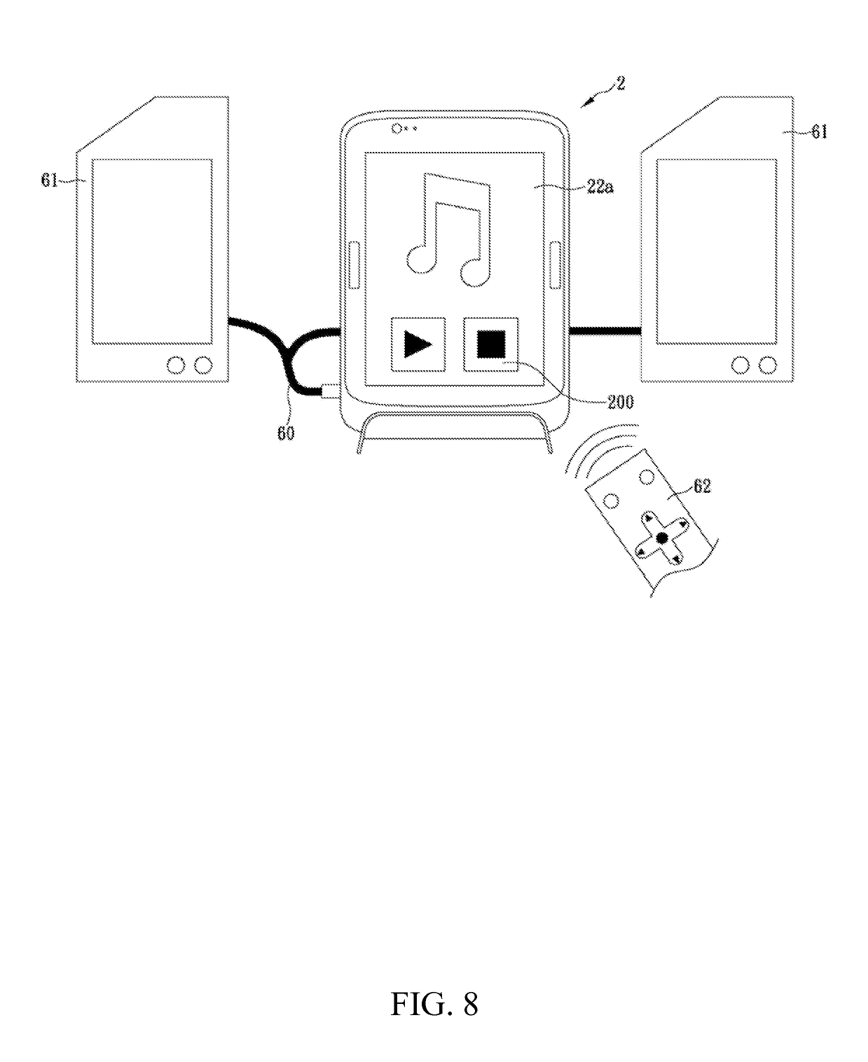

FIG. 8 is a schematic view of a mobile device in a remote operation mode in accordance with the second preferred embodiment of the present invention; and

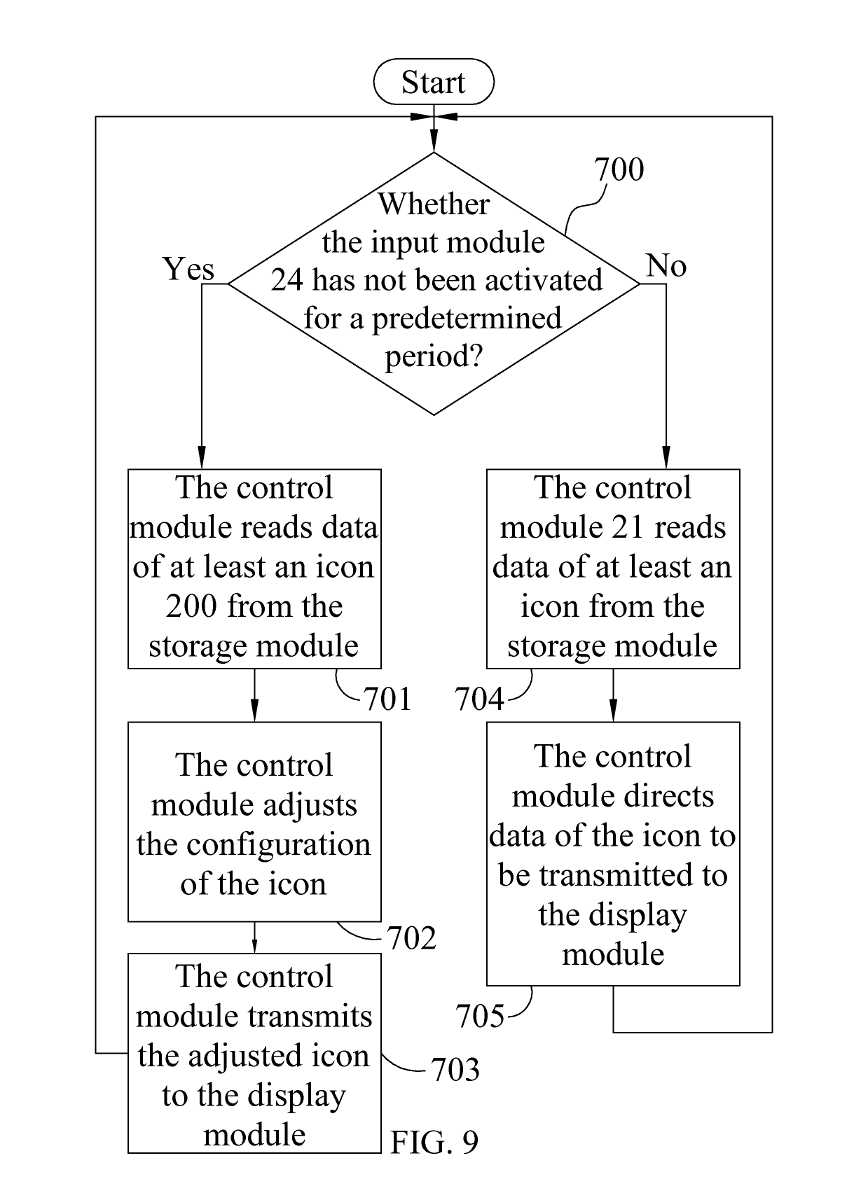

FIG. 9 is a flow chart of a method of automatically switching an operation mode in accordance with a third preferred embodiment of the present invention.

### DETAILED DESCRIPTION OF THE PREFERRED EMBODIMENTS

During the research on the mobile device, the inventor of the present invention found that a conventional mobile device cannot automatically switch its operation mode, so that users have to switch the operation mode manually, which is very inconvenient to the users. Although some manufacturers have started investing on the research and development of similar devices and seeking solutions, yet no feasible solution is provided. In view of the situation above, the inventor of the present invention uses triggering by conditions of the hardware or software of the mobile device to achieve the effect of the mobile device automatically switching to a short-distance operation mode or a remote operation mode.

FIG. 2 is a schematic circuit diagram of a mobile device in accordance with embodiments of the present invention. The mobile device is capable of automatically switching its operation modes. In FIG. 2, the mobile device 2 is a smart phone, but the present invention is not limited to a smart phone only. The mobile device 2 also may be a tablet PC, a personal digital assistant (PDA) or an e-book reader. The mobile device 2 comprises a storage module 20, a control module 21, a display module 22 and the first and the second electrical connectors 23a, 23b, wherein the first electrical connector 23a is a power connector, and the second electrical connector 23b is an audio signal connector. The storage module 20 is configured to store data of a plurality of icons 200 (as shown in FIG. 3), and each of the icons 200 is controllable to execute an application or a function. The application may be a music playing program, an image capturing program, or an instant communication program, and the function may be a PLAY, STOP, PREVIOUS, or NEXT function of the music playing program.

FIG. 3 is a schematic view of a mobile device in a short-distance operation mode in accordance with the first preferred embodiment of the present invention. In FIG. 3, the mobile device 2 includes a screen 22a (such as a liquid crystal display), wherein the screen 22a and a display circuit (not shown in the figure) constitute the display module 22 (as shown in FIG. 2) for displaying images or data. In this preferred embodiment, the operating interface is shown on a standby screen, and each of the icons 200 is controllable to execute an application. In FIG. 2, the control module 21 is coupled to the storage module 20, the display module 22 and the electrical connectors 23a, 23b. In FIG. 3, the mobile device 2 is in the short-distance operation mode. Accordingly, if the user carries a mobile device 2 and operates the mobile phone 2, and the mobile device 2 has not been electrically coupled to any other electronic device, the control module 21 is configured to direct the data of at least one of the icons 200 from the storage module 2 to be transmitted to the display module 22, for displaying the at least one icon 200 on the screen 22a. It is worthy to note that in this preferred embodiment, the screen 22a in the short-distance operation mode would show six icons 200 simultaneously, but the present invention is not limited to such arrangement only, and related manufacturers can vary the size of the mobile device 2 when designing or manufacturing the mobile device 2 according to the present invention, so that the screen 22a in the short-distance operation mode can display more icons 200 to facilitate users' selecting and operating. Therefore, the users can select an icon by clicking the icon at a short distance, so that the mobile device 2 can execute the application corresponding to the selected icon 200.

FIG. 4 is a schematic view of a mobile device in a remote operation mode in accordance with the first preferred embodiment of the present invention. In the first preferred embodiment with reference to FIGS. 2 and 4, the mobile device 2 is electrically coupled to a charger 40 through the first electrical connector 23a, and the charger 40 can supply power to the mobile device 2 through the first electrical connector 23a, and also may be able to support the mobile device 2 to keep the mobile device 2 at an upright position and prevent it from falling down. If the control module 21 detects that the first electrical connector 23a is electrically coupled to the charger 40, then the control module 21 is configured to adjust configuration of the at least one icon 200, with the adjusted configuration to be automatically displayed on the screen to mark a new operation mode of the mobile device. The configuration of the icons 200 may be adjusted in size, one or more pixels, position or quantity of the at least one icon 200.

In this preferred embodiment, the configuration of the at least one icon 200 may be adjusted in size of the at least one icon 200. The control module 21 may adjust configuration of the at least one icon 200 to obtain an adjusted configuration wherein size of the at least one icon 200 is increased by a predetermined ratio. In this embodiment, the predetermined ratio may be two times of the size before adjustment, but the present invention is not limited to such ratio only. The control module 21 may then immediately transmits the adjusted configuration with the size-increased icon 200 to the display module 22, for displaying the adjusted configuration on the screen 22a, and enables the mobile device 2 to enter a remote operation mode. With the foregoing technical characteristics, the control module 21 may adjust configuration of the at least one icon 200 for not displaying at least one icon 200 on the screen 22a after the adjustment, so that the quantity of the displayed icons 200 after the adjustment is less than the quantity of displayed icons 200 before the adjustment. The control module 21 may be configured to determine quantity of the at least one icon 200 to be displayed on the screen 22a after the adjustment, according to times or frequency of execution or usage of the application or function, or according to user-determined priority of the application or function. In FIG. 4, the size of the at least one icon 200 is increased after the adjustment, so that the lower section of the screen 22a can accommodate the display of only three size-increased icons 200. Therefore even if the distance between the user and the mobile device 2 is as long as 3 to 5 meters, the user can still recognize the size-increased icons 200 and then operate the mobile device 2 by e.g. selecting the icons 200 with remote control or other methods.

In this preferred embodiment, the control module 21 may be configured to increase the size of the at least one icon 200 by the same predetermined ratio, but the invention is not limited to such arrangement only. The control module 21 also may be configured to increase the size of the at least one icon 200 by different predetermined ratios according to times or frequency of execution or usage of the application or function, or according to user-determined priority of the application or function.

FIG. 5 is another schematic view of a mobile device in a remote operation mode in accordance with the first preferred embodiment of the present invention. In this preferred embodiment with reference to FIG. 5, the configuration of the at least one icon 200 may be adjusted in position of the at least one icon 200 displayed on the screen 22a. In this case, the adjusted configuration is to be automatically displayed in a larger area on the screen 22a than an area on the screen 22a in which the configuration before the adjustment is displayed, so that the size of the at least one icon 200 before the adjustment can be increased when displayed on the screen 22a after the adjustment. In other words, six size-increased icons 200 can be displayed on the screen 22a simultaneously after the adjustment. In another embodiment, the adjusted icons 200 are displayed sequentially on the screen 22a, and the displaying order is different from the displaying order of the icons 200 on the screen 22a before the adjustment. For example, the displaying order is determined by times or frequency of execution or usage of the application or function, or according to user-determined priority of the application or function.

In some embodiments, the configuration of the at least one icon 200 is adjusted in one or more pixels of the icon 200 on the screen 22a. In one embodiment, the control module 21 is configured to convert a primary-color-combination image value (comprising e.g. the three primary colors red, green, and blue) of each pixel of the icon 200 into a grayscale image value or a binary-image value such as black-and-white image value to obtain the adjusted configuration, which are shown in black and white to produce a strong contrast in vision. The control module 21 can convert the primary-color-combination image value into the grayscale image value by a method such as averaging the R, G, and B values. In another embodiment, the control module 21 is configured to convert the primary-color-combination image value (RGB) of each pixel of the icon 200 into another primary-color-combination image value to obtain the adjusted configuration, which is therefore displayed in e.g. one color tone (such as orange). Therefore the user can set the color tone of the adjusted configuration according to his preference. The control module 21 can convert the primary-color-combination image value into another primary-color-combination image value by e.g. a method of multiplying the R, G, and B values by a coefficient.

In the foregoing first preferred embodiment, if the mobile device 2 is not coupled to any electronic device, as shown in FIG. 3, the mobile device 2 will remain in the short-distance operation mode and display the icon 200 with the original size. On the other hand, if the mobile device 2 is coupled to another electronic device (such as a charger 40), as shown in FIGS. 4 and 5, the mobile device 2 can automatically switch to a remote operation mode and display the icon 200 with a larger size. Therefore, user manual operation is not required to switch the mobile device 2 to an appropriate operation mode. In other words, without the need to manually adjust the operation mode of the mobile device 2, the user can view the displayed icons having a larger quantity or smaller sizes, displayed more-finely drawn icons, or displayed icons with more colors, in a short-distance operation mode of the mobile device 2. And in the remote operation mode of the mobile device 2, the user can view the displayed icons having a smaller quantity or larger sizes, displayed more-coarsely drawn icons, displayed icons with less or simpler colors, or displayed icons with obvious contrast of their colors. With the present invention, the mobile device 2 not only can switch its operation modes according to different conditions, but also can enhance the convenience in operating the mobile device 2 according to the preference of the user.

FIG. 6 is a flow chart of a method of automatically switching an operation mode in accordance with the first preferred embodiment of the present invention. To understand the aforementioned procedure, FIG. 2 and FIG. 6 are referenced for illustration. The control module 21 can switch the operation mode of the mobile device 2 by the following steps:

Step 500: The control module 21 determines whether or not the first (or second) electrical connector 23a (or 23b) is connected to another electronic device; if yes, go to Step 501; if it's not, go to Step 504.

Step 501: The control module 21 reads data of at least an icon 200 from the storage module 20.

Step 502: The control module 21 adjusts configuration of the icon 200.

Step 503: The control module 21 directs data of the adjusted icon 200 to be transmitted to the display module 22 for displaying the adjusted configuration on the screen 22a, wherein the configuration of the icon 200 may be adjusted in size, one or more pixels, position or quantity of the icon 200.

Step 504: The control module 21 reads data of at least an icon 200 from the storage module 20.

Step 505: The control module 21 directs data of the icon 200 to be transmitted to the display module 22 for displaying the configuration of icon 200 which is not adjusted on the screen 22a.

As described above, the mobile device 2 in FIG. 4 is in the remote operation mode. In this first preferred embodiment, the mobile device 2 may display an size-increased clock on the screen 22a for the user to view, but the invention is not limited to such arrangement, and manufacturers can vary the design of the mobile device 2, so that when the mobile device 2 enters into a remote operation mode, various images or pictures can be played or displayed automatically on the mobile device 2, as analogous to a digital photo frame used to view photos. Numerous modifications and variations could be made thereto by those skilled in the art without departing from the scope and spirit of the invention set forth in the claims.

FIG. 7 is a schematic view of a mobile device in a short-distance operation mode in accordance with a second preferred embodiment of the present invention. With reference to FIGS. 2 and 7, in the second preferred embodiment, an operating interface is shown on the screen in FIG. 7 after an application is executed, and the icon 200 is controllable to execute a function of the application. In this embodiment, the application is a music playing program and the function may be a Play-current-song function, a Stop-playing function, a Play-previous-song function, or a Play-next-song function in the music playing program. If the mobile device 2 is not electrically coupled to any other electronic device, the control module 21 may direct the data of at least one icon 200 from the storage module 20 to be transmitted to the display module 22 for displaying the icon 200.

FIG. 8 is a schematic view of a mobile device in a remote operation mode in accordance with the second preferred embodiment of the present invention. With reference to FIGS. 2 and 8, in the second preferred embodiment, the second electrical connector 23b (which is an audio signal connector) of the mobile device 2 may be electrically coupled to a speaker 61 through an audio signal line 60. When the control module 21 detects that the second electrical connector 23b is connected to the speaker 61, the configuration of the icon 200 may be adjusted. The configuration of the icon 200 may be adjusted in size, one or more pixels, position or quantity of the icon 200. In the second preferred embodiment, the configuration of the icons 200 is adjusted in size and quantity of the icon 200. The control module 21 may adjust the configuration of the icon 200 to increase its size by a predetermined ratio (such as four times), and decide not to display at least one of the icons 200, and then the control module 21 may direct data of the adjusted icon 200 to be transmitted to the display module 22 for displaying the adjusted configuration of the icons 200. In the second preferred embodiment, the adjusted icons 200 may include a “PLAY” button and a “STOP” button whose sizes have been increased by a predetermined ratio. At this time, the mobile device 2 of this preferred embodiment may be analogous to a music player in a remote operation mode, and the user can use e.g. a remote control 62 to operate the mobile device 2 from a remote distance.

In one embodiment, the control module 21 is configured to convert the primary-color-combination image value (RGB) of each pixel of the icon 200 into a grayscale image value to obtain the adjusted configuration. In another embodiment, the control module 21 is configured to convert the primary-color-combination image value (RGB) of each pixel of the icon 200 into another primary-color-combination image value to obtain the adjusted configuration. In another embodiment, the adjusted icons 200 are displayed sequentially on the screen 22a, and the displaying order is different from the displaying order of the icons 200 on the screen 22a before the adjustment.

In the foregoing first and second preferred embodiments, the mobile device 2 may switch to a remote operation mode or a short-distance operation mode according to the hardware conditions (whether or not it is connected to an external electronic device). In a third preferred embodiment of the present invention, with reference to FIG. 2, the mobile device 2 can switch its operation mode depending on conditions of software on the mobile device 2. In the third preferred embodiment, the mobile device 2 further comprises an input module 24 coupled to the control module 21. The input module 24 may be a touch module of the mobile device 2 for receiving a physical motion such as pressing or clicking by the user to input instructions and data, but the invention is not limited to such arrangement only. The input module 24 may include a hardware device such as a button instead. In addition, the storage module 20 may be the same as that of the aforementioned preferred embodiments, and is configured to store data of a plurality of icons, with each of the icons controllable to execute an application or a function.

FIG. 9 is a flow chart of a method of automatically switching an operation mode in accordance with the third preferred embodiment of the present invention. With reference to FIGS. 2 and 9, the control module 21 can switch the operation mode of the mobile device 2 by the following steps:

Step 700: The control module 21 determines whether the input module 24 has not been activated (such as by being pressed or clicked) for a predetermined period (such as one minute); if yes, then go to Step 701; if not, go to Step 704.

Step 701: The control module 21 reads data of at least an icon 200 from the storage module 20.

Step 702: The control module 21 adjusts configuration of the icon 200.

Step 703: The control module 21 directs data of the adjusted icon 200 to be transmitted to the display module 22, for displaying the adjusted configuration on the screen 22a, wherein the configuration of the icons 200 may be adjusted in size, one or more pixels, position or quantity of the icon 200.

Step 704: The control module 21 reads data of at least an icon 200 from the storage module 20.

Step 705: The control module 21 directs data of the icon 200 to be transmitted to the display module 22, for displaying the configuration of icon 200 which is not adjusted on the screen 22a.

In Step 700, if the time for the mobile device 2 to be idle is greater than the predetermined period, this means that the input module 24 has not been activated (such as by being pressed or clicked) for the predetermined period, then the mobile device 2 may automatically switch to a remote operation mode and adjust the configuration of the icon 200. On the other hand, if the user is operating the mobile device 2 from a short distance by activating the input module 24, and the time for the mobile device 2 to be idle does not exceed the predetermined period, then the mobile device 2 may remain in a short-distance operation mode, and may not adjust the configuration of the icon 200. As a result, the mobile device 2 can display icons having a larger quantity or smaller sizes, more-finely drawn icons, or icons with more colors, in a short-distance operation mode of the mobile device 2, to facilitate the user's short-distance operation.

With the aforementioned technical characteristics, if the user stays at a position remote from the mobile device 2, and after the mobile device 2 is idle for a certain period of time, the mobile device 2 may automatically switch to a remote operation mode. Therefore, user manual operation is not required to switch the mobile device 2 to a remote operation mode, in which the user can view the displayed icons having a smaller quantity or larger sizes, displayed more-coarsely drawn icons, displayed icons with less or simpler colors, or displayed icons with obvious contrast of their colors, which improves the convenience in operating the mobile device 2 from a remote position.

In summation of the description above, the present invention complies with the patent application requirements, and is thus duly filed for patent application. While the invention has been described with reference to a preferred embodiment thereof, it is to be understood that modifications or variations may be easily made without departing from the spirit of this invention, which is defined in the appended claims.

What is claimed is:

1. A mobile device capable of automatically switching its operation modes, comprising:
a storage module, configured to store data of a plurality of icons, each of the icons controllable to execute an application or a function;
a display module, configured to display images or data;
an electrical connector, configured to couple to an electronic device; and
a control module, coupled to the storage module, the display module, and the electrical connector, and configured to direct the data of at least one of the icons from the storage module to be transmitted to the display module for displaying the at least one icon on a screen of the display module, wherein when the control module detects that the electrical connector is electrically coupled to the electronic device, the control module is configured to adjust configuration of the at least one icon, with the adjusted configuration to be automatically displayed on the screen to mark a new operation mode of the mobile device.

2. The mobile device of claim 1, wherein the configuration of the at least one icon is adjusted in size, one or more pixels, position on the screen, or quantity of the at least one icon.

3. The mobile device of claim 1, wherein when the control module detects that the electrical connector is coupled to the electronic device the control module is configured to increase size of the at least one icon by a predetermined ratio to obtain the adjusted configuration.

4. The mobile device of claim 1, wherein when the control module detects that the electrical connector is coupled to the electronic device the control module is configured to increase size of the at least one icon by different ratios to obtain the adjusted configuration.

5. The mobile device of claim 1, wherein when the control module detects that the electrical connector is coupled to the electronic device the control module is configured to reduce quantity of the at least one icon to be displayed on the screen.

6. The mobile device of claim 1, wherein when the control module detects that the electrical connector is coupled to the electronic device the control module is configured to convert a primary-color-combination image value of each pixel of the at least one icon into a grayscale image value, a binary-image value, or another primary-color-combination image value, to obtain the adjusted configuration.

7. The mobile device of claim 1, wherein the adjusted configuration is to be automatically displayed in a larger area on the screen than an area on the screen in which the configuration before the adjustment is displayed.

8. The mobile device of claim 1, wherein the adjusted configuration has icon display order different from the icon display order of the configuration before the adjustment.

9. The mobile device of claim 1, wherein when the control module detects that the electrical connector is coupled to the electronic device the control module is configured to determine quantity of the at least one icon to be displayed on the screen, according to times or frequency of execution or usage of the application or function, or according to user-determined priority of the application or function.

10. The mobile device of claim 1, wherein the electrical connector comprises a power connector or an audio signal connector.

11. A mobile device capable of automatically switching its operation modes, comprising:
a storage module, configured to store data of a plurality of icons, each of the icons controllable to execute an application or a function;
a display module, configured to display images or data;
an input module, configured for inputting instructions or data; and
a control module, coupled to the storage module, the display module, and the input module, and configured to direct the data of at least one of the icons from the storage module to be transmitted to the display module for displaying the at least one icon on a screen of the display module, wherein when the control module detects that the input module has not been activated for a predetermined period, the control module is configured to adjust configuration of the at least one icon, with the adjusted configuration to be automatically displayed on the screen to mark a new operation mode of the mobile device.

12. The mobile device of claim 11, wherein the configuration of the at least one icon is adjusted in size, one or more pixels, position on the screen, or quantity of the at least one icon.

13. The mobile device of claim 11, wherein when the control module detects that the input module has not been activated for a predetermined period the control module is configured to increase size of the at least one icon by a predetermined ratio to obtain the adjusted configuration.

14. The mobile device of claim 11, wherein when the control module detects that the input module has not been activated for a predetermined period the control module is configured to reduce quantity of the at least one icon on the screen.

15. The mobile device of claim 11, wherein when the control module detects that the input module has not been activated for a predetermined period, the control module is configured to convert a primary-color-combination image value of each pixel of the at least one icon into a grayscale image value, a binary-image value, or another primary-color-combination image value, to obtain the adjusted configuration.

16. The mobile device of claim 11, wherein the adjusted configuration is to be automatically displayed in a larger area on the screen than an area on the screen in which the configuration before the adjustment is displayed.

17. The mobile device of claim 11, wherein the adjusted configuration has icon display order different from the icon display order of the configuration before the adjustment.
